(19) United States
(12) Patent Application Publication
(10) Pub. No.: US 2026/0229659 A1
(43) Pub. Date: Aug. 6, 2026

(54) SECONDARY BATTERY AND BATTERY MODULE INCLUDING THE SECONDARY BATTERY

(71) Applicant: SAMSUNG SDI CO., LTD., Yongin-si (KR)

(72) Inventors: Ryang Hoon KIM, Yongin-si (KR); Yeong Beom JOE, Yongin-si (KR); Seung Yeol YOO, Yongin-si (KR); Hyeok Joo KIM, Yongin-si (KR)

(21) Appl. No.: 19/399,873

(22) Filed: Nov. 25, 2025

(30) Foreign Application Priority Data
Jan. 24, 2025 (KR) 10-2025-0011129

(51) Int. Cl. H01M 50/172; H01M 50/528; H01M 50/533; H01M 50/147

(52) U.S. Cl. CPC H01M 50/172; H01M 50/528; H01M 50/533; H01M 50/147

(57) ABSTRACT

A secondary battery including a case and an electrode assembly disposed inside the case and provided with a first electrode and a second electrode. A cap plate is coupled to the case and faces the electrode assembly. A tab member is connected to the electrode and extends toward the cap plate. A first terminal extends through the cap plate and spaced from the tab member. A sub-plate is disposed between the tab member and the terminal, with the sub-plate being connected to the tab member and the terminal.

### CROSS-REFERENCE TO RELATED APPLICATION

The present application claims priority to and the benefit of Korean Patent Application No. 10-2025-0011129, filed on January 24, 2025, in the Korean Intellectual Property Office, the entire disclosure of which is incorporated herein by reference.

### BACKGROUND

### Field of the Disclosure

The present disclosure relates to a secondary battery and a battery module including the secondary battery.

### Discussion of Related Art

With the recent proliferation of electronic devices using batteries such as mobile phones, notebook computers, and electric vehicles, the demand for secondary batteries having high energy density and high capacity has rapidly increased. Thus, research and development for improving the performance of a lithium secondary battery are being actively conducted.

A lithium secondary battery includes a positive electrode and a negative electrode including active materials capable of intercalating and deintercalating lithium ions, and an electrolyte solution. A lithium secondary battery generates energy through oxidation/reduction reactions when lithium ions are intercalated/deintercalated at the positive and negative electrodes.

The information disclosed in this background of the present disclosure is only intended to improve understanding the present disclosure and may include information that does not constitute the related or prior art.

### SUMMARY OF THE DISCLOSURE

The present disclosure is directed to providing a secondary battery that is capable of reducing component resistance and a battery module including the secondary battery.

These and other aspects and features of the present disclosure will be described in or will be apparent from the following description of some embodiments of the present disclosure.

According to an aspect of the present disclosure, there is provided a secondary battery including: a case; an electrode assembly disposed inside the case and provided with a first electrode and a second electrode; a cap plate coupled to the case and facing the electrode assembly; a tab member connected to the first electrode and extending toward the cap plate; a terminal extending through the cap plate and spaced from the tab member; and a sub-plate disposed between the tab member and the terminal, with the sub-plate connected to the tab member and the terminal.

The sub-plate may include a current collector plate provided with an inner surface facing the tab member and an outer surface facing the cap plate, with the current collector plate being connected to the first tab member, and a connecting plate extending from the current collector plate and connected to the terminal.

The tab member may be in contact with the inner surface and the outer surface.

The tab member may include an inner contact portion in contact with the inner surface, and an outer contact portion extending from the inner contact portion and in contact with the outer surface.

The inner contact portion and the outer contact portion are parallel to each other and face each other with the current collector plate interposed therebetween.

The outer surface may be spaced from the terminal, and the outer contact portion may be disposed between the outer surface and the terminal.

The outer contact portion may be in contact with the terminal.

The connecting plate may include an extending plate extending from the current collector plate facing the outer surface, and a terminal contact portion extending from the extending plate and in contact with an outer surface of the terminal.

The extending plate may be spaced from the outer surface, and the outer contact portion may be disposed between the outer surface and the extending plate.

The outer contact portion may be in contact with the extending plate.

A plurality of tab members may be provided, and the sub-plate may include a center plate, a plurality of current collector plates extending from the center plate and facing the tab members, and a connecting plate extending from the current collector plate and connected to the terminal.

The center plate may be in contact with the terminal.

Each of the current collector plates may include an inner surface facing one of the tab members and an outer surface opposite to the inner surface, the outer surface facing and spaced from the terminal, and each of the tab members may be in contact with the inner surface and the outer surface of one of the current collector plates.

The secondary battery may further include a terminal extending portion extending from the terminal toward the outer surface of one of the current collector plates and in contact with one of the tab members.

The terminal extending portion may surround the center plate.

The sub-plate may include a current collector plate provided with an inner surface facing the electrode assembly and an outer surface facing the cap plate, a connecting plate extending from the current collector plate and connected to the terminal, and an insertion hole extending between the inner surface and the outer surface, and the tab member may be connected to the connecting plate through the insertion hole.

The connecting plate may include a extending plate, provided with (i) an inner extending surface extending from the current collector plate and facing the outer surface, and (ii) an outer extending surface facing the cap plate, and a terminal contact portion extending from the extending plate and in contact with an outer surface of the terminal, and the tab member may include an insertion portion inserted into the insertion hole, an inner contact portion extending from the insertion portion and in contact with the inner extending surface, and an outer contact portion extending from the inner contact portion and in contact with the outer extending surface.

A pair of inner contact portions may be provided and the pair of inner contact portions may branch off in different directions from the insertion portion.

The secondary battery may further include a second tab member connected to the second electrode and extending toward the cap plate, a second terminal extending through the cap plate and spaced apart from the second tab member, and a second sub-plate disposed between the second tab member and the second terminal and connected to the second tab member and the second terminal.

According to another aspect of the present disclosure, there is provided a battery module including a housing; and a plurality of secondary batteries disposed inside the housing, wherein each of the secondary batteries includes: a case; an electrode assembly disposed inside the case and provided with a first electrode and a second electrode; a cap plate coupled to the case and facing the electrode assembly; a tab member connected to the first electrode and extending toward the cap plate; a terminal extending through the cap plate and spaced apart from the tab member; and a sub-plate disposed between the tab member and the terminal, with the sub-plate connected to the tab member and the terminal.

### BRIEF DESCRIPTION OF THE DRAWINGS

The drawings attached to this specification illustrate embodiments of the present disclosure and further describe aspects and features of the present disclosure together with the detailed description of the present disclosure. However, the present disclosure is not limited to the embodiments depicted in the drawings.

FIG. 1 is a perspective view of a configuration of a battery module according to a first embodiment of the present disclosure;

FIG. 2 is a perspective view of a configuration of a secondary battery according to the first embodiment of the present disclosure;

FIG. 3 is an exploded perspective view the configuration of the secondary battery according to the first embodiment of the present disclosure;

FIG. 4 is a view of an electrode assembly according to the first embodiment of the present disclosure;

FIG. 5 is a perspective view of an installation state of a first sub-plate according to the first embodiment of the present disclosure;

FIG. 6 is a front view of the installation state of the first sub-plate according to the first embodiment of the present disclosure;

FIG. 7 is a cross-sectional view along line 7-7' in FIG. 6;

FIGS. 8 to 11 are views of a connection process of a first tab member, a first sub-plate, and a first terminal according to the first embodiment of the present disclosure;

FIG. 12 is a front view of an installation state of a second sub-plate according to the first embodiment of the present disclosure;

FIG. 13 is a cross-sectional view along line 13-13' in FIG. 12;

FIG. 14 is a perspective view of a configuration of a secondary battery according to a second embodiment of the present disclosure;

FIG. 15 is a perspective view of an installation state of a first sub-plate according to the second embodiment of the present disclosure;

FIG. 16 is a front view of the installation state of the first sub-plate according to the second embodiment of the present disclosure;

FIG. 17 is a perspective view of an installation state of a second sub-plate according to the second embodiment of the present disclosure;

FIG. 18 is a front view of the installation state of the second sub-plate according to the second embodiment of the present disclosure;

FIG. 19 is a cross-sectional view of a configuration of a secondary battery according to a third embodiment of the present disclosure;

FIG. 20 is a front view of an installation state of a first sub-plate according to a fourth embodiment of the present disclosure;

FIG. 21 is a cross-sectional view along line 21-21' in FIG. 20;

FIG. 22 is a bottom perspective view of a configuration of the first sub-plate according to the fourth embodiment of the present disclosure;

FIG. 23 is a front view of an installation state of a second sub-plate according to the fourth embodiment of the present disclosure;

FIG. 24 is a cross-sectional view along line 24-24' in FIG. 23; and

FIG. 25 is a bottom perspective view of a configuration of a second sub-plate according to the fourth embodiment of the present disclosure.

### DETAILED DESCRIPTION OF EXEMPLARY EMBODIMENTS

Embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein includes all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an element is referred to as being arranged (or located or positioned) on the "above (or below)" or "on (or under)" a component, it may mean that the element is placed in contact with the upper (or lower) surface of the component and may also mean that another component may be interposed between the component and any element arranged (or located or positioned) on (or under) the component.

In addition, it is to be understood that when an element is referred to as being “coupled,” “linked,” or "connected" to another element, the elements may be directly “coupled,” “linked,” or "connected" to each other, or one or more intervening elements may be present therebetween, through which the element may be “coupled,” “linked,” or “connected” to another element. In addition, when a part is referred to as being "electrically coupled" to another part, the part may be directly electrically connected to another part or one or more intervening parts may be present therebetween such that the part and the another part are indirectly electrically connected to each other.

Throughout the specification, when "A and/or B" is stated, it means A, B, or A and B, unless otherwise stated. That is, “and/or” includes any or all combinations of a plurality of items enumerated. When "C to D" is stated, it means C or more and D or less, unless otherwise specified.

The terms used in the present specification are for describing embodiments of the present disclosure and are not intended to limit the present disclosure.

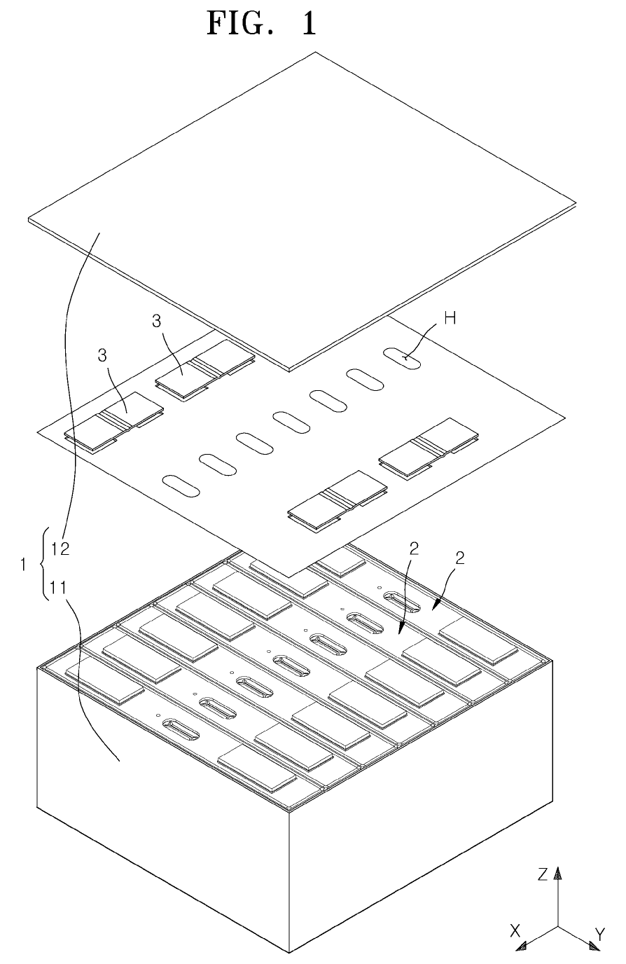

FIG. 1 is a perspective view of a configuration of a battery module according to a first embodiment of the present disclosure.

Referring to FIG. 1, the battery module according to the present embodiment may include a housing 1 and a secondary battery 2.

A first direction described herein refers to a direction of the X-axis as depicted in FIG. 1, a second direction refers to a direction of a Y-axis as depicted in FIG. 1, and a third direction refers to a direction of a Z-axis as depicted in FIG. 1.

The housing 1 forms an exterior of the battery module and provides a space in which the secondary battery 2 may be accommodated. The housing 1 according to the present embodiment may include a housing body 11 and a cover 12.

The housing body 11 may be formed in a box shape with an empty interior and an open side. A cross-sectional shape of the housing body 11 is not limited to the rectangular shape illustrated in FIG. 1, but rather may be various other shapes such as a polygonal shape, a circular shape, an oval shape, and the like.

The cover 12 may be coupled to the housing body 11 and close the interior space of the housing body 11. The cover 12 may be formed to have a roughly plate-shaped form and may be disposed to face the open side of the housing body 11. The cover 12 may be fixed to the housing body 11 by various types of coupling methods such as bolting, welding, fitting, and the like.

The secondary battery 2 may function as a unit structure that stores and supplies power from the battery module. One or more secondary batteries 2 may be disposed inside the housing 1.

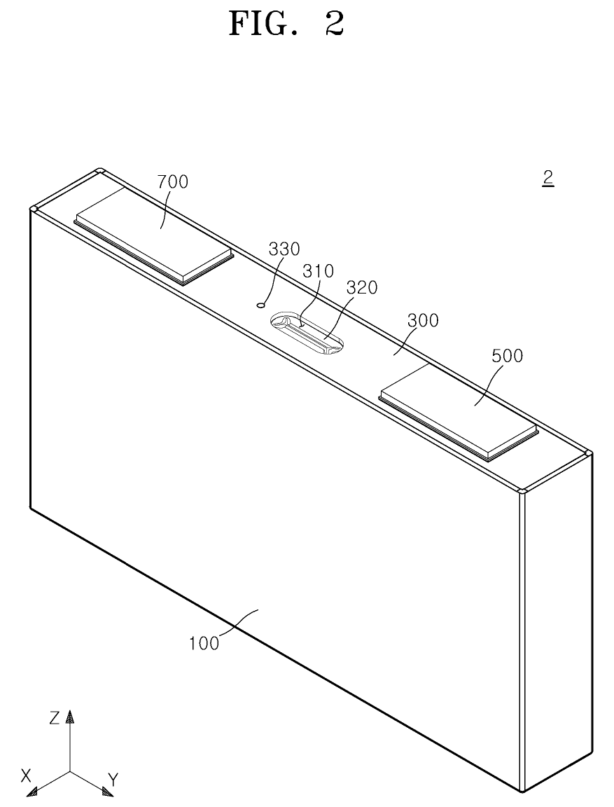

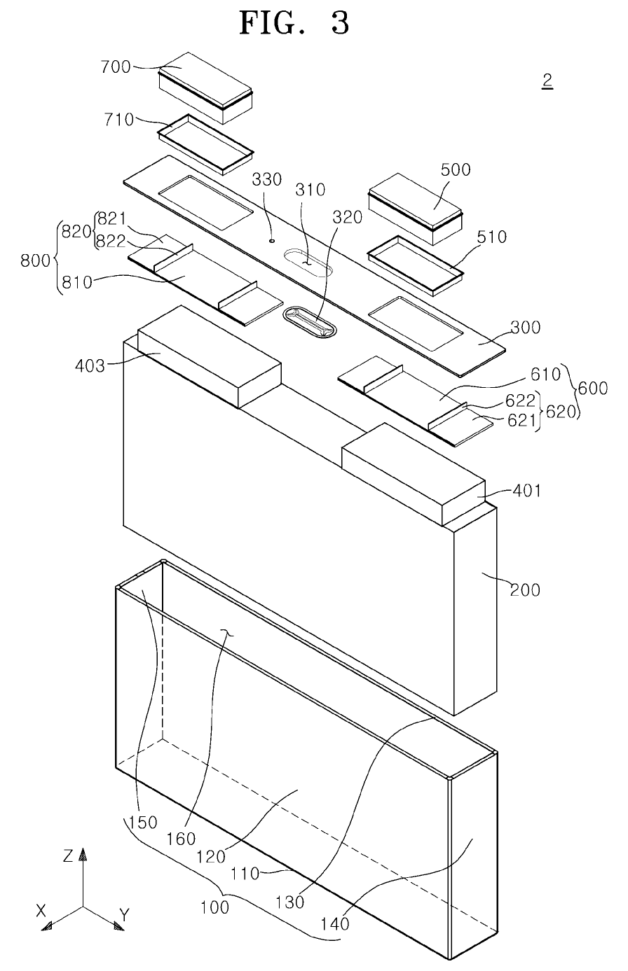

FIG. 2 is a perspective view a configuration of a secondary battery according to the first embodiment of the present disclosure, and FIG. 3 is an exploded perspective view of the configuration of the secondary battery according to the first embodiment of the present disclosure.

Hereinafter, an example in which the secondary battery is a prismatic lithium-ion secondary battery will be described. However, the present disclosure is not limited thereto, and the secondary battery may be, for example, a lithium polymer battery or a cylindrical battery.

Referring to FIGS. 2 and 3, the secondary battery 2 according to the present embodiment includes a case 100, an electrode assembly 200, a cap plate 300, a first tab member 401, a first terminal 500, a first sub-plate 600.

The case 100 forms an exterior of the secondary battery 2 and may accommodate the electrode assembly 200. The case 100 according to the present embodiment may include a bottom portion 110, a front surface portion 120, a rear surface portion 130, a first side portion 140, and a second side portion 150.

The bottom portion 110 may form an exterior of at lower side (based on FIG. 3) of the case 100. The bottom portion 110 may in the form of a rectangular plate. The bottom portion 110 may be seated on a bottom surface of the housing body 11 shown in FIG. 1.

The front surface portion 120, the rear surface portion 130, the first side portion 140, and the second side portion 150 may form an exterior of an outer surface of the case 100. The front surface portion 120, the rear surface portion 130, the first side portion 140, and the second side portion 150 may have the form plates extending upward (based on FIG. 3) from edges of the bottom portion 110. The front surface portion 120, the rear surface portion 130, the first side portion 140, and the second side portion 150 may be disposed to surround the space above the bottom portion 110. The front surface portion 120, the rear surface portion 130, the first side portion 140, and the second side portion 150 may be disposed to form a rectangular cross-sectional shape of the battery 2.

The front surface portion 120 and the rear surface portion 130 may be disposed to face each other in the first direction, with the front surface portion 120 and the rear surface portion 130 being parallel to each other. Areas of the front surface portion 120 and the rear surface portion 130 may be the same. The first side portion 140 and the second side portion 150 may be disposed to face each other in the second direction, with the first side portion 140 and the second side portion 150 being parallel to each other. Areas of the first side portion 140 and the second side portion 150 may be the same. The areas of the first side portion 140 and the second side portion 150 may be less than the areas of the front surface portion 120 and the rear surface portion 130.

The case 100 may further include an opening 160. The opening 160 may refer to a space surrounded by upper end portions of the front surface portion 120, the rear surface portion 130, the first side portion 140, and the second side portion 150. The opening 160 may interconnect the space inside and outside the case 100. Accordingly, the case 100 according to the present embodiment may have the shape of a rectangular parallelepiped with an open upper side.

The electrode assembly 200 may function as a unit structure that performs charging and discharging operations of power in the secondary battery. The electrode assembly 200 may be accommodated inside the case 100.

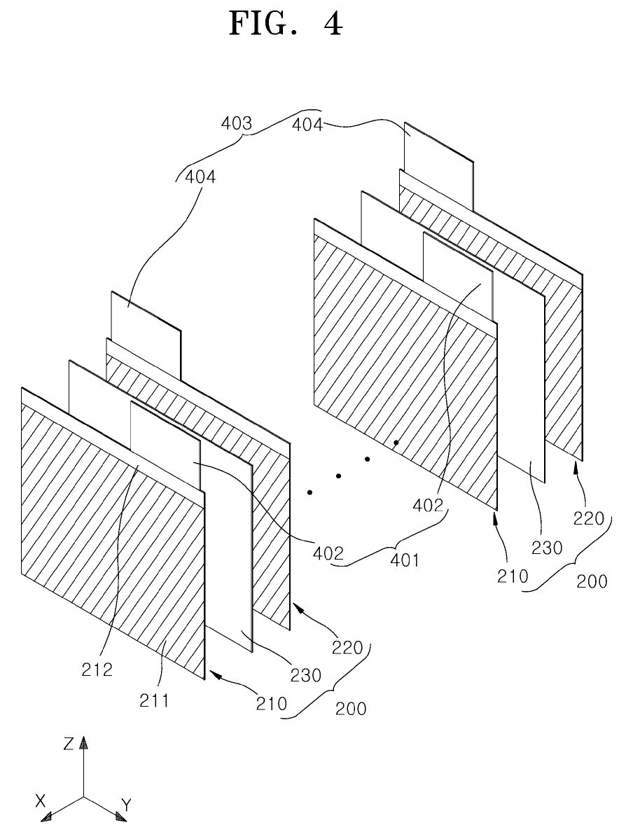

FIG. 4 is a view of a configuration of an electrode assembly according to the first embodiment of the present disclosure.

Referring to FIGS. 2 to 4, the electrode assembly 200 according to the present embodiment may include a first electrode 210, a second electrode 220, and a separator 230 disposed between the first electrode 210 and the second electrode 220. A plurality of first electrodes 210, separators 230, and second electrodes 220 may be provided.

Hereinafter, an electrode assembly 200 having a stacked form in which the plurality of first electrodes 210, separators 230, and second electrodes 220 are sequentially stacked in the first direction will be described as an example. However, the electrode assembly 200 is not limited to this form. For example, in other embodiments, the electrode assembly may be formed such that the first electrode 210, the separator 230, and the second electrode 220 are stacked and wound in a clockwise or counterclockwise direction around a winding axis.

The first electrode 210 may function as either a positive electrode or a negative electrode of the electrode assembly 200. Hereinafter, the first electrode 210 will be described as a positive electrode of the electrode assembly 200 as an example. However, the first electrode 210 is not limited thereto. In other embodiments, the first electrode 210 may function as a negative electrode of the electrode assembly 200.

The first electrode 210 according to the present embodiment may a foil including a metal material such as aluminum or an aluminum alloy. But the type, size, and shape of the first electrode 210 is not limited as long as it is conductive and does not cause chemical changes in a secondary battery. A cross-sectional shape of the first electrode 210 may be designed to have various shapes other than the rectangular shape illustrated in FIG. 4.

A plurality of first electrodes 210 may be provided. The plurality of first electrodes 210 may be arranged in the first direction between the front surface portion 120 and the rear surface portion 130 of the case 100. The number of first electrodes 210 may vary depending on the charging capacity or the like of the secondary battery 2.

A first active material layer 211 may be applied to at least a portion of the first electrode 210. The first active material layer 211 may be applied to both surfaces of the first electrode 210. In other embodiments, the first active material layer 211 may be applied to only one surface of the first electrode 210.

In an embodiment, as the first electrode 210 functions as a positive electrode, the first active material layer 211 may include a positive electrode active material. The positive electrode active material may be a compound capable of reversible intercalation and deintercalation of lithium (a lithiated intercalation compound). More specifically, as the positive electrode active material, one or more of composite oxides of a metal selected from cobalt, manganese, nickel, iron, and a combination thereof and lithium may be used. As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0 < x < 1, 0 < y <1, 0 < z < 1, and x+y+z = 1. The positive electrode active material may include only one of lithium-iron-phosphorus oxide (LiFePO4, LFP), lithium-manganese-iron-phosphorus oxide (LiMnFePO₄, LMFP), and lithium-nickel-cobalt-manganese oxide (LiNiₓCo_{y}Mn_{z}O₂, NCM) or may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCoyMn_{z}O₂, NCM).

The first active material layer 211 may further include a positive electrode conductive material.

The positive electrode conductive material is used to impart conductivity to the first active material layer 211, and any electronically conductive material that does not cause a chemical change may be used. Examples of the positive electrode conductive material may include carbon-based materials such as natural graphite, artificial graphite, carbon black, acetylene black, Ketjen black, carbon fibers, carbon nanofibers, and carbon nanotubes, metal-based materials in the form of a metal powder or metal fibers containing copper, nickel, aluminum, silver, and the like, conductive polymers such as polyphenylene derivatives, or a mixture thereof.

The first active material layer 211 may further include a positive electrode binder.

The positive electrode binder serves to attach the particles constituting the positive electrode active material to each other, and also attach the positive electrode active material to the first electrode 210.

Examples of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the positive electrode binder, the aqueous binder may further include a cellulose series compound capable of imparting viscosity. As the cellulose series compound, one or more of carboxymethyl cellulose, hydroxypropylmethyl cellulose, methyl cellulose, and an alkali metal salt thereof may be mixed and used. The alkali metal may be Na, K, or Li.

The dry binder may be a polymer material capable of being fiberized, for example, polytetrafluoroethylene, polyvinylidene fluoride, a polyvinylidene fluoride-hexafluoropropylene copolymer, polyethylene oxide, or a combination thereof.

The first electrode 210 may include a first uncoated portion 212 where the first active material layer 211 is not applied. The first uncoated portion 212 may be disposed at an upper end area of the first electrode 210, which is disposed to face the opening 160 inside the case 100. However, the first uncoated portion 212 is not limited to this configuration, and the first uncoated portion 212 may also be formed over an entire edge area of the first electrode 210.

The second electrode 220 may function as the other of a positive electrode or a negative electrode of the electrode assembly 200. Hereinafter, the second electrode 220 will be described as a negative electrode of the electrode assembly 200 as an example. However, the second electrode 220 is not limited thereto, and the second electrode 220 may function as a positive electrode of the electrode assembly 200.

A plurality of second electrodes 220 may be provided. The plurality of second electrodes 220 may be arranged in the first direction between the front surface portion 120 and the rear surface portion 130 of the case 100. The first electrode 210 and the second electrode 220 may be alternately disposed in the first direction. The second electrode 220 may be spaced a predetermined distance apart from the first electrode 210 in the first direction.

The second electrode 220 according to the present embodiment may be a foil including a metal material such as copper, a copper alloy, nickel or a nickel alloy. The type, size, and shape of the second electrode 220 is not limited in as long as it is conductive and does not cause chemical changes in a secondary battery. A cross-sectional shape of the second electrode 220 may various shapes other than the rectangular shape illustrated in FIG. 4.

A second active material layer 221 may be applied to at least a portion of the second electrode 220. The second active material layer 221 may be applied to both surfaces of the second electrode 220, or alternatively, may be applied to only one surface of the second electrode 220.

As the second electrode 220 functions as a negative electrode, the second active material layer 221 may include a negative electrode active material. The negative electrode active material may include a material capable of reversible intercalation/deintercalation of lithium ions, a lithium metal, a lithium metal alloy, a material capable of doping and dedoping of lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon include graphite such as amorphous, plate-like, flake-like, spherical, or fiber-like natural graphite or artificial graphite. Examples of the amorphous carbon include soft carbon, hard carbon, mesophase pitch carbide, calcined coke, or the like.

As the lithium metal alloy, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedepoing of lithium, a Si-based negative electrode active material or a Sn-based negative electrode active material may be used. The Si-based negative electrode active material may be silicon, a silicon-carbon composite, SiOx (0 < x ≤ 2), a Si-Q alloy or a combination thereof. In the formula Si-Q, Q is selected from an alkali metal, an alkaline earth metal, a Group 13 element, a Group 14 element (excluding Si), a Group 15 element, a Group 16 element, a transition metal, a rare earth element, and a combination thereof. The Sn-based negative electrode active material may be Sn, SnOₓ (0 < x ≤ 2, e.g., SnO₂), a Sn-based alloy, or a combination thereof.

The silicon-carbon composite may be a composite of silicon and amorphous carbon. According to one embodiment, the silicon-carbon composite may be in the form of silicon particles and amorphous carbon coated on surfaces of the silicon particles. In an example, the silicon-carbon composite includes a secondary particle (core) in which primary silicon particles are aggregated and an amorphous carbon coating layer (shell) located on a surface of the secondary particle. The amorphous carbon may be located between the primary silicon particles so that the primary silicon particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si-based negative electrode active material or Sn-based negative electrode active material may be used in combination with a carbon-based negative electrode active material.

The second active material layer 221 may further include a negative electrode conductive material and a negative electrode binder.

The negative electrode conductive material is used to provide conductivity to the second active material layer 221, and any electronically conductive material that does not cause a chemical change in a secondary battery may be used. Examples of the negative electrode conductive material may include carbon-based materials such as natural graphite, artificial graphite, carbon black, acetylene black, Ketjen black, carbon fibers, carbon nanofibers, and carbon nanotubes, metal-based materials in the form of a metal powder or metal fibers containing copper, nickel, aluminum, silver, or the like, conductive polymers such as polyphenylene derivatives, or a mixture thereof.

The negative electrode binder serves to attach particles constituting the negative electrode active material and also serves to attach the negative electrode active material to the second electrode 220. Examples of the negative electrode binder include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, the aqueous binder may further include a cellulose series compound capable of giving viscosity. As the cellulose series compound, one or more of carboxymethyl cellulose, hydroxypropylmethyl cellulose, methyl cellulose, and an alkali metal salt thereof may be mixed and used. The alkali metal may be Na, K, or Li.

The dry binder may be a polymer material capable of being fiberized. Examples of the dry binder include polytetrafluoroethylene, polyvinylidene fluoride, a polyvinylidene fluoride-hexafluoropropylene copolymer, polyethylene oxide, or a combination thereof.

The second electrode 220 may include a second uncoated portion 222 where the second active material layer 221 is not applied. The second uncoated portion 222 according to the present embodiment may be disposed in an upper end area of the second electrode 220 that faces the opening 160 inside the case 100. However, the second uncoated portion 222 is not limited to this arrangement. For example, the second uncoated portion 222 may be formed over an entire edge area of the second electrode 220.

The separator 230 may be disposed between the first electrode 210 and the second electrode 220. The separator 230 may perform the function of preventing a short circuit between the first electrode 210 and the second electrode 220 while allowing the movement of lithium ions between the first electrode 210 and the second electrode 220.

The separator 230 may be disposed to entirely surround the surface area of the electrode assembly 200. Accordingly, the separator 230 may prevent the first electrode 210 and the second electrode 220 from being directly exposed to outside of the electrode assembly 200.

The separator 230 may be made of polyethylene, polypropylene, polyvinylidene fluoride, or a multilayer film of two or more layers thereof, and a mixed multilayer film such as a two-layer separator of polyethylene/polypropylene, a three-layer separator of polyethylene/polypropylene/polyethylene, or a three-layer separator of polypropylene/polyethylene/polypropylene may be used. The separator 230 may include a porous substrate and a coating layer including an organic material, an inorganic material, or a combination thereof, which is positioned on one surface or both surfaces of the porous substrate. The porous substrate may be a polymer film made from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, TEFLON®, and polytetrafluoroethylene, or a copolymer or mixture of two or more of the above materials.

The organic material may include a polyvinylidene fluoride-based polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited to these examples. The organic material and the inorganic material may be mixed in one coating layer or may be in the form of a coating layer including (or containing) an organic material and a coating layer including (or containing) an inorganic material which are stacked on each other.

The cap plate 300 is coupled to the case 100 and seals the case 100. The cap plate 300 may be formed as a flat plate shape. The cap plate 300 may be disposed in the opening 160 of the case 100 and parallel to the bottom portion 110 of the case 100. The cap plate 300 may be seated on an upper end portion of the case 100. More specifically, the cap plate 300 may be seated on the upper end portion of the front surface portion 120, the rear surface portion 130, the first side portion 140, and the second side portion 150. The cap plate 300 may be coupled to the case 100 by various types of coupling methods such as welding, bolting, fitting, and the like. An inner surface of the cap plate 300 may be disposed to face the electrode assembly 200 in the third direction.

A vent hole 310 and a vent 320 may be formed in the cap plate 300. The vent hole 310 may be formed as a hole that vertically passes between surfaces of the cap plate 300 in the third direction. The vent hole 310 may provide a path for flames, gas, smoke, and the like formed inside the case 100 to be discharged to outside of the case 100 when thermal runaway of the secondary battery occurs due to overcurrent or the like. A cross-sectional shape of the vent hole 310 may be formed in various shapes such as an oval, a circle, and a polygon.

The vent 320 is provided in the vent hole 310 and may be opened and closed in response to changes in the internal pressure of the case 100. That is, during normal operation of the secondary battery 2, the vent 320 may close the vent hole 310 to prevent the electrolyte or the like inside the case 100 from leaking out of the case 100 and to prevent moisture, foreign substances, and the like from entering the case 100. The vent 320 may open the vent hole 310 when thermal runaway of the secondary battery 2 occurs to guide the discharge of flames, gas, smoke, and the like formed inside the case 100 to outside of the case 100.

The vent 320 according may be formed to have a roughly plate-shaped form. The vent 320 may be fixed to the cap plate 300 by various types of coupling methods such as welding, bolting, fitting, and the like. The vent 320 may be disposed inside the vent hole 310, or the vent 320 may be disposed on an upper side or a lower side of the cap plate 300 to face the vent hole 310 in the third direction.

The thickness of the vent 320 may be less than the thickness of the cap plate 300. Accordingly, the vent 320 may easily rupture or break when the internal pressure of the case 100 increases. The vent 320 may include a notch formed concavely inward in the vent 320 so as to be preferentially broken when the internal pressure of the case 100 increases.

The cap plate 300 may have an electrolyte inlet 330 passing through the cap plate 300 and in which a sealing plug may be installed. The electrolyte inlet 330 may be spaced a predetermined distance apart from the vent hole 310 in the second direction.

The first tab member 401 may be connected to the first electrode 210 and may extend from the electrode assembly 200 toward the plate 300. As the first electrode 210 is exemplified as a positive electrode, the first tab member 401 may function as a positive electrode tab of the secondary battery 2. However, the first tab member 401 is not limited thereto. And when the first electrode 210 is a negative electrode, the first tab member 401 may function as a negative electrode tab of the secondary battery 2.

The first tab member 401 may include a first tab 402. The first tab 402 may be a foil extending in the third direction from the first uncoated portion 212 of the first electrode 210. The first tab 402 may have a rectangular shape. However, the shape of the first tab 402 is not limited thereto, and the first tab may be various other shapes.

The first tab 402 may be formed integrally with the first electrode 210. For example, the first tab 402 may be the remaining area of the first uncoated portion 212 after a portion of the first uncoated portion 212 is cut or removed by notching processing or the like. Alternatively, the first tab 402 may be made separately from the first electrode 210 and then connected to the first uncoated portion 212 by welding or the like. A material of the first tab 402 may be the same as that of the first electrode 210.

A plurality of first tabs 402 may be provided. The number of first tabs 402 may be the same as the number of first electrodes 210. Each of the first tabs 402 may individually extend from the first uncoated portion 212 of a different first electrode 210. Adjacent first tabs 402 face each other in the first direction and be disposed parallel to each other. Accordingly, the first tab member 401 may be an assembly of a plurality of first tabs 402 stacked in the first direction. The adjacent first tabs 402 may be in contact with each other and may also be spaced apart by the thickness of the separator 230.

The first terminal 500 may pass through the cap plate 300 and may be spaced apart from the first tab member 401. The first terminal 500 may be formed from an electrically conductive material such as aluminum, nickel, copper, or the like. The first terminal 500 may be electrically connected to the first electrode 210 by the first tab member 401 and the first sub-plate 600. As the first electrode 210 functions as a positive electrode, the first terminal 500 may be exemplified as a positive electrode terminal of the secondary battery 2.

The first terminal 500 may be inserted into the inside of the cap plate 300. An upper end portion of the first terminal 500 may protrude outward from the cap plate 300, and a lower end portion of the first terminal 500 may be disposed inside the case 100. In FIG. 3, the first terminal 500 is illustrated as having a rectangular cross-sectional shape as an example, but the cross-sectional shape of the first terminal 500 is not limited thereto. Rather, the first terminal 500 may be formed in various other shapes such as a circular shape, an oval shape, a polygonal shape, etc.

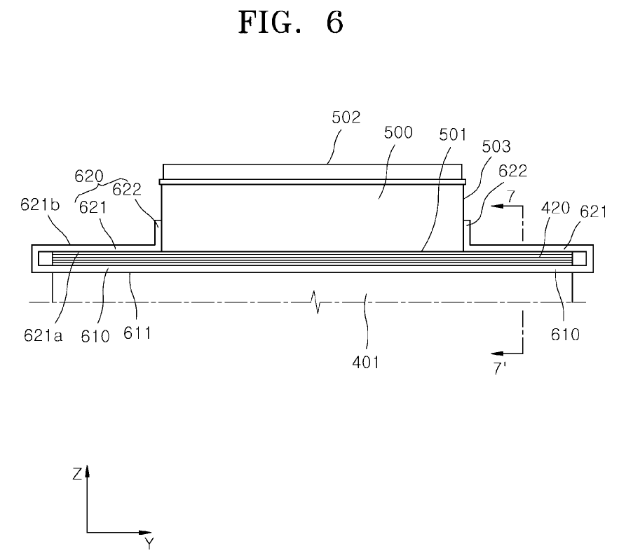

The first terminal 500 may include a first inner terminal surface 501 and a first outer terminal surface 502 (see FIG. 6).

The first inner terminal surface 501 may be disposed inside the case 100, and may be exemplified as a lower surface of the first terminal 500 that faces the electrode assembly 200 in the third direction. The first inner terminal surface 501 may be disposed to be spaced apart from the first tab member 401.

The first outer terminal surface 502 may protrude outward from the cap plate 300. The first outer terminal surface 502 may be exemplified as an upper surface of the first terminal 500 that is opposite to the first inner terminal surface 501. The first outer terminal surface 502 may be disposed parallel to the first inner terminal surface 501.

A first gasket 510 may be positioned between the cap plate 300 and the first terminal 500. The first gasket 510 may electrically insulate the cap plate 300 and the first terminal 500 and may prevent moisture or foreign substances from entering between the cap plate 300 and the first terminal 500. The first gasket 510 may be formed of an insulating material such as polyethylene (PE), polypropylene (PP), polyethylene terephthalate (PET), rubber, etc. The first gasket 510 may be fixed between the cap plate 300 and the first terminal 500 by pressing, injection, adhesion, etc.

The first sub-plate 600 may be disposed between the first tab member 401 and the first terminal 500 and may be connected to the first tab member 401 and the first terminal 500. The first sub-plate 600 may electrically interconnect the first tab member 401 and the first terminal 500. Thus, the first sub-plate 600 may be formed of a conductive material such as copper, aluminum, nickel, etc.

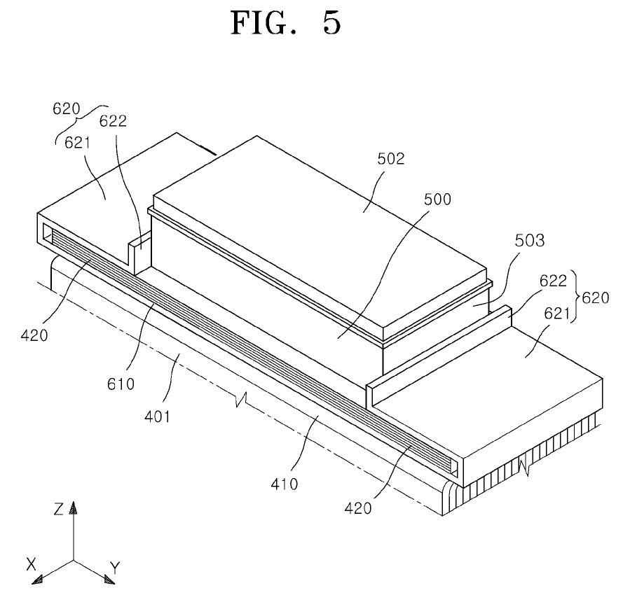

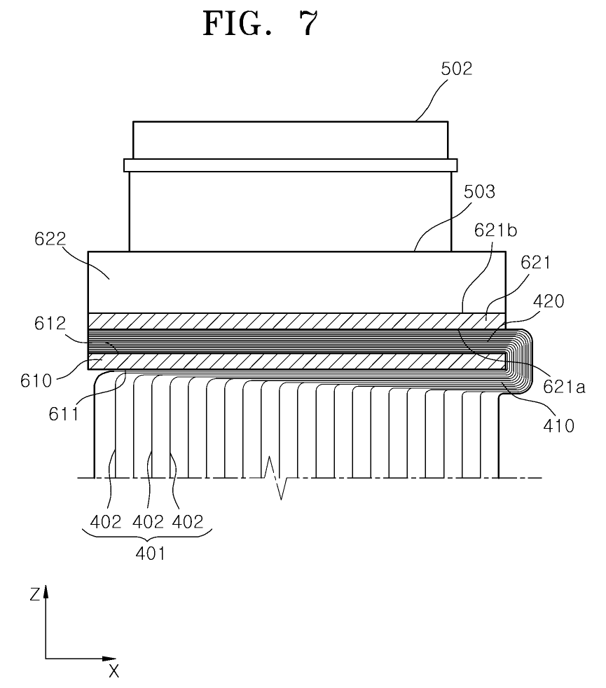

FIG. 5 is a perspective view of an installation state of a first sub-plate according to the first embodiment of the present disclosure, FIG. 6 is a front view of the installation state of the first sub-plate according to the first embodiment of the present disclosure, and FIG. 7 is a cross-sectional view along line 7-7' in FIG. 6.

Referring to FIGS. 5 to 7, the first sub-plate 600 according to the present embodiment includes a first current collector plate 610 and a first connecting plate 620. The first current collector plate 610 may form an exterior of one side of the first sub-plate 600 and may be connected to the first tab member 401. The first current collector plate 610 according to the present embodiment may be disposed between the first tab member 401 and the cap plate 300. The first current collector plate 610 may include a first inner surface 611 facing the first tab member 401 and a first outer surface 612 facing the cap plate 300. The first inner surface 611 and the first outer surface 612 may be perpendicular to the third direction. A central portion of the first outer surface 612 may be disposed to face the first inner terminal surface 501 in the third direction. The central portion of the first outer surface 612 may be spaced a predetermined distance apart from the first inner terminal surface 501.

The first tab member 401 may be in contact with the first inner surface 611 and the first outer surface 612. As an example, the first tab member 401 may include a first inner contact portion 410 in contact with the first inner surface 611 and a first outer contact portion 420 in contact with the first outer surface 612.

The first inner contact portion 410 may be disposed parallel to the first inner surface 611. The first inner contact portion 410 may be formed by bending an upper area of the first tab member 401, which extends from the electrode assembly 200 in the third direction, in parallel with the first direction. The first inner contact portion 410 may be in contact with the first inner surface 611 and joined to the first inner surface 611 by laser welding.

The first outer contact portion 420 may be disposed parallel to the first outer surface 612. The first inner contact portion 410 and the first outer contact portion 420 may be disposed parallel to each other with the first current collector plate 610 interposed therebetween.

The first outer contact portion 420 may be formed by bending an end area of the first inner contact portion 410, which is not in direct contact with the first inner surface 611, toward the first outer surface 612. The first outer contact portion 420 may be in contact with the first outer surface 612. An end portion of the first outer contact portion 420 may not protrude outward from the first outer surface 612. The first outer contact portion 420 may be joined to the first outer surface 612 by laser welding.

Accordingly, all of the plurality of first tabs 402 of the secondary battery 2 can be connected to the first current collector plate 610 without increasing the width of the first sub-plate 600 in the first direction. In addition, the secondary battery 2 according may have reduced electrical resistance between the first tab member 401 and the first terminal 500 and decreased temperature rise by due to the increased contact area between the first tab member 401 and the first sub-plate 600.

A portion of the first outer contact portion 420 may be disposed between the first outer surface 612 and the first terminal 500, more specifically, between the first outer surface 612 and the first inner terminal surface 501. The first outer contact portion 420 may be in direct contact with the first inner terminal surface 501. With such a configuration, the secondary battery 2 may have further reduced the electrical resistance between the first tab member 401 and the first terminal 500.

The first connecting plate 620 may extend from the first current collector plate 610 and may be connected to the first terminal 500. A plurality of first connecting plates 620 may be provided. In an example embodiment, a pair of first connecting plates 620 may be provided. The pair of first connecting plates 620 may face each other in the second direction. The pair of first connecting plates 620 may be disposed symmetrically on both sides of the first current collector plate 610.

The first connecting plate 620 may include a first extending plate 621 and a first terminal contact portion 622.

The first extending plate 621 may extend from the first current collector plate 610 and may be disposed to face the first outer surface 612. The first extending plate 621 may be bent from an end portion of the first current collector plate 610 toward the first outer surface 612. The first extending plate 621 may be disposed between the first current collector plate 610 and the cap plate 300. The first extending plate 621 may include a first inner extending surface 621a facing the first outer surface 612 and a first outer extending surface 621b facing the cap plate 300. The first inner extending surface 621a and the first outer extending surface 621b may be perpendicular to the third direction. The first inner extending surface 621a and the first outer extending surface 621b may be parallel to each other. The first inner extending surface 621a may be spaced a predetermined distance apart from the first outer surface 612 in the third direction.

The first outer contact portion 420 may be disposed between the first outer surface 612 and the first inner extending surface 621a of the first extending plate 621. Surfaces of the first outer contact portion 420 may be in contact with the first outer surface 612 and the first inner extending surface 621a. The first outer contact portion 420 may be connected to the first extending plate 621 by laser welding.

The first terminal contact portion 622 may extend from the first extending plate 621 and may be in contact with an outer surface 503 of the first terminal 500.

The first terminal contact portion 622 according may be bent in the third direction from an end portion of the first extending plate 621. The first terminal contact portion 622 may be parallel to the outer surface 503 of the first terminal 500and in contact with the outer surface 503 of the first terminal 500. The first terminal contact portion 622 may be joined to the outer surface 503 of the first terminal 500 by laser welding. Accordingly, the secondary battery 2 may be made in a simplified manufacturing process and improve the current density by directly connecting the first sub-plate 600 to the first terminal 500 without a separate current collecting component.

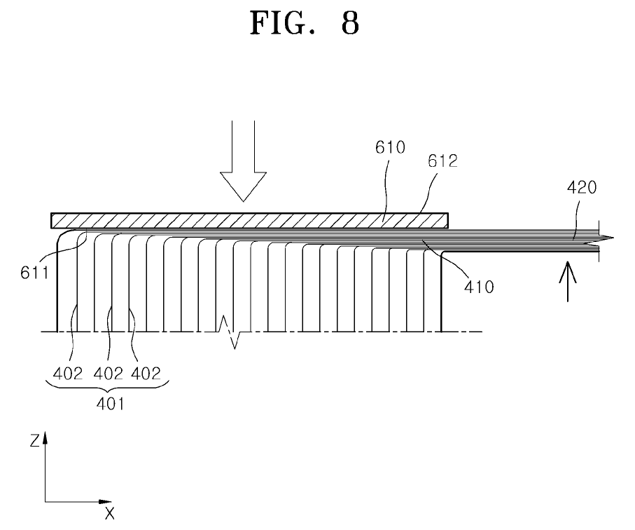

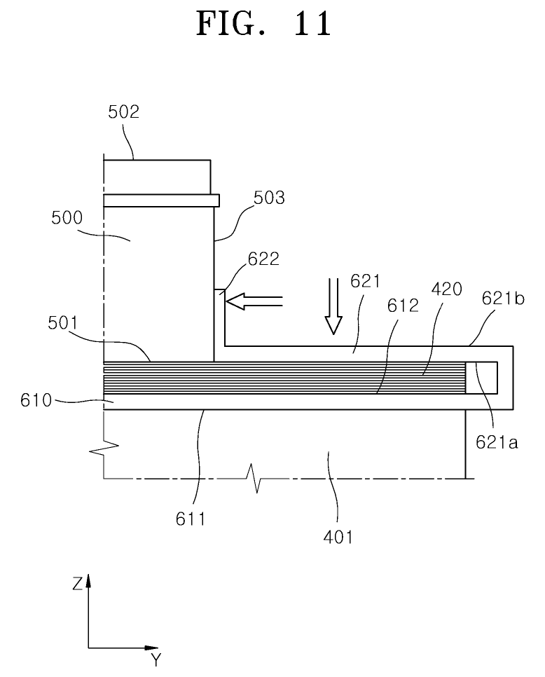

FIGS. 8 to 11 are views schematically illustrating a connection process of a first tab member, a first sub-plate, and a first terminal according to the first embodiment of the present disclosure.

Referring to FIG. 8, the upper area of the first tab member 401 is bent parallel to the first direction to form the first inner contact portion 410. Then, the first inner surface 611 is brought into contact with the first inner contact portion 410, and the first current collector plate 610 and the first inner contact portion 410 are joined by laser welding.

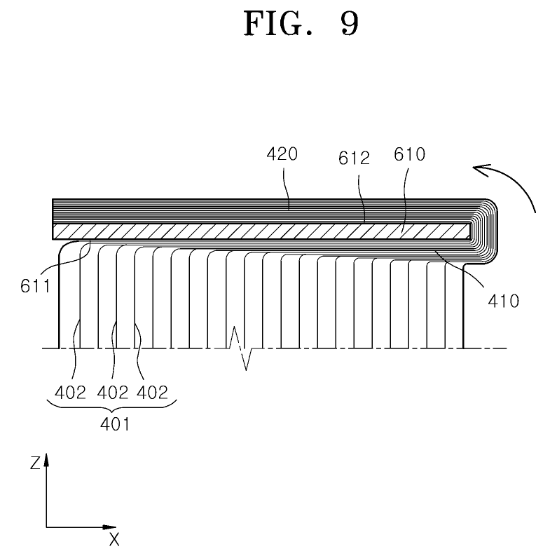

Referring to FIG. 9, the first outer contact portion 420 is formed by bending an end portion of the first inner contact portion 410, which protrudes outward from the first current collector plate 610, toward the first outer surface 612. Then, the first outer contact portion 420 is brought into contact with the first outer surface 612. And the first current collector plate 610 and the first outer contact portion 420 are joined by laser welding.

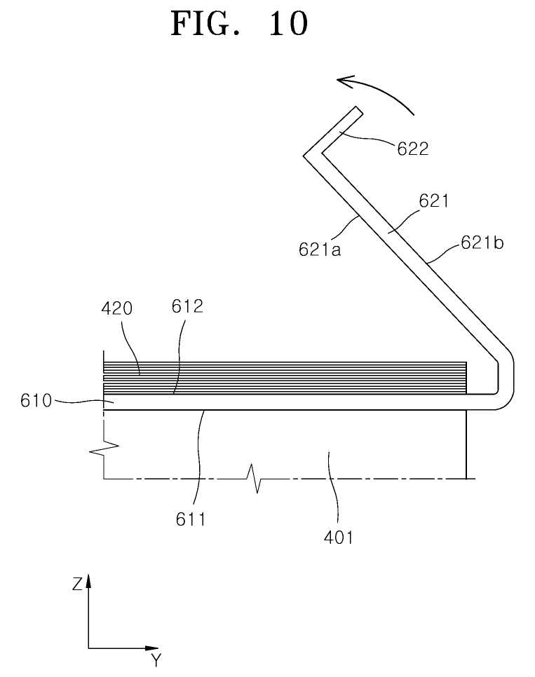

Referring to FIG. 10, an end area of the first current collector plate 610 that is not in direct contact with the first tab member 401 is bent toward the first outer surface 612 to form the first extending plate 621. Then, the first inner extending surface 621a of the first extending plate 621 is brought into contact with the first outer contact portion 420, and the first extending plate 621 and the first outer contact portion 420 are joined by laser welding.

As the first inner extending surface 621a and the first outer contact portion 420 come into contact, the first terminal contact portion 622 comes into contact with the outer surface 503 of the first terminal 500. Then, the first terminal contact portion 622 is joined to the outer surface 503 of the first terminal 500 by laser welding.

The secondary battery 2 according to the present embodiment may further include a second tab member 403, a second terminal 700, and a second sub-plate 800.

The second tab member 403 may be connected to the second electrode 220 and may extend from the electrode assembly 200 toward the plate 300. As the second electrode 220 is exemplified as a negative electrode, the second tab member 403 may function as a negative electrode tab of the secondary battery 2. However, the second tab member 403 is not limited thereto, and when the second electrode 220 is a positive electrode, it may function as a positive electrode tab of the secondary battery 2. The first tab member 401 and the second tab member 403 may be spaced apart in the second direction.

The second tab member 403 may include a second tab 404. The second tab 404 may be a foil extending in the third direction from the second uncoated portion 222 of the second electrode 220. The second tab 404 may have a rectangular shape. However, the shape of the second tab 404 is not limited thereto, and the second tab 404 may be various other shapes.

The second tab 404 may be formed integrally with the second electrode 220. For example, the second tab 404 may be the area of the second uncoated portion 222 that remains after a portion of the second uncoated portion 222 is cut or removed by notching processing or the like. Alternatively, the second tab 404 may be made separately from the second electrode 220 and then connected to the second uncoated portion 222 by welding or the like. A material of the second tab 404 may be the same as that of the second electrode 220.

A plurality of second tabs 404 may be provided. The number of second tabs 404 may be the same as the number of second electrodes 220. Each of the second tabs 404 may extend from the second uncoated portion 222 of a different second electrode 220. Adjacent second tabs 404 may face each other in the first direction. The adjacent second tabs 404 may be disposed parallel to each other. Accordingly, the second tab member 403 may be an assembly of a plurality of second tabs 404 stacked in the first direction. The adjacent second tabs 404 may be in contact with each other and may also be spaced apart by the thickness of the separator 230.

The second terminal 700 may pass through the cap plate 300 and may be spaced apart from the second tab member 403. The second terminal 700 may be formed of an electrically conductive material such as aluminum, nickel, copper, or the like. The second terminal 700 may be electrically connected to the second electrode 220 by the second tab member 403 and the second sub-plate 800. As the second electrode 220 functions as a negative electrode, the second terminal 700 may be exemplified as a negative electrode terminal of the secondary battery 2.

The second terminal 700 may be inserted into the cap plate 300. An upper end portion of the second terminal 700 may protrude outward from the cap plate 300, and a lower end portion of the second terminal 700 may be disposed inside the case 100. In FIG. 3, the second terminal 700 is illustrated as having a rectangular cross-sectional shape as an example, but the cross-sectional shape of the second terminal 700 is not limited to thereto. In other embodiments, the second terminal 700 may be formed in various other shapes such as a circular shape, an oval shape, a polygonal shape, etc.

The first terminal 500 and the second terminal 700 may be spaced apart in the second direction. The first terminal 500 and the second terminal 700 may to face each other in the second direction with the vent 320 therebetween.

The second terminal 700 may include a second inner terminal surface 701 and a second outer terminal surface 702. The second inner terminal surface 701 may be disposed inside the case 100 and may be exemplified as a lower surface of the second terminal 700 that faces the electrode assembly 200 in the third direction. The second inner terminal surface 701 may be spaced apart from the second tab member 403.

The second outer terminal surface 702 according to the present embodiment may protrude outward from the cap plate 300. The second outer terminal surface 702 may be exemplified as the upper surface of the second terminal 700, which is opposite to the second inner terminal surface 701. The second outer terminal surface 702 may be disposed parallel to the first inner terminal surface 501.

A second gasket 710 may be positioned between the cap plate 300 and the second terminal 700. The second gasket 710 may electrically insulate the cap plate 300 and the second terminal 700 and may prevent moisture or foreign substances from entering between the cap plate 300 and the second terminal 700.

The second gasket 710 may be formed from an insulating material such as polyethylene (PE), polypropylene (PP), polyethylene terephthalate (PET), rubber, etc. The second gasket 710 may be fixed between the cap plate 300 and the second terminal 700 by pressing, injection, adhesion, etc.

The second sub-plate 800 may be disposed between the second tab member 403 and the second terminal 700 and may be connected to the second tab member 403 and the second terminal 700. The second sub-plate 800 may electrically interconnect the second tab member 403 and the second terminal 700. Thus, the second sub-plate 800 may be formed of a conductive material such as copper, aluminum, nickel, etc.

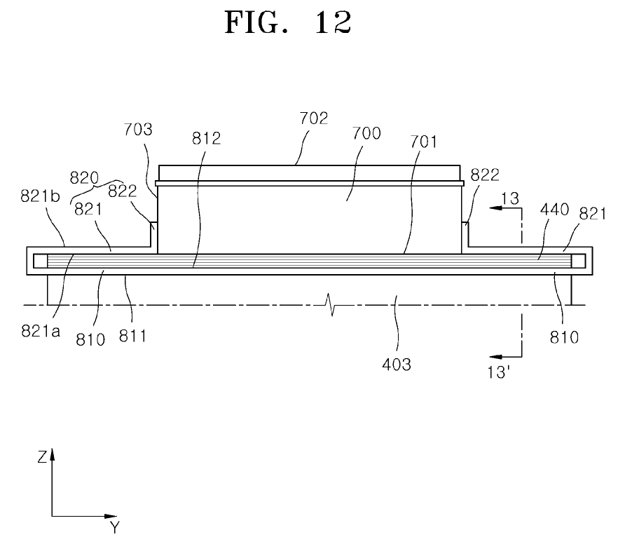

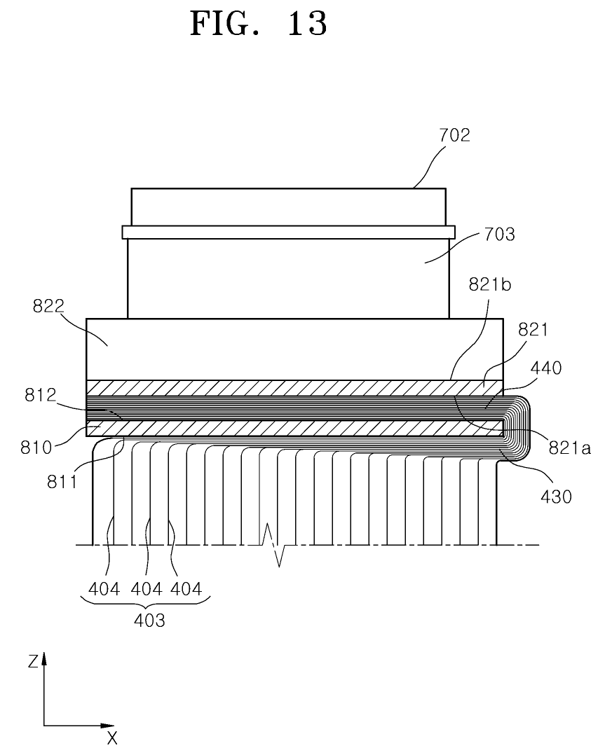

FIG. 12 is a front view of an installation state of a second sub-plate according to the first embodiment of the present disclosure, and FIG. 13 is a cross-sectional view along line 13-13' in FIG. 12.

Referring to FIGS. 12 and 13, the second sub-plate 800 according to the present embodiment includes a second current collector plate 810 and a second connecting plate 820.

The second current collector plate 810 may form an exterior of one side of the second sub-plate 800 and may be connected to the second tab member 403. The second current collector plate 810 may be disposed between the second tab member 403 and the cap plate 300. The second current collector plate 810 may include a second inner surface 811 facing the second tab member 403 and a second outer surface 812 facing the cap plate 300. The second inner surface 811 and the second outer surface 812 may be perpendicular to the third direction. A central portion of the second outer surface 812 may face the second inner terminal surface 701 in the third direction. The central portion of the second outer surface 812 may be spaced a predetermined distance apart from the second inner terminal surface 701.

The second tab member 403 may be in contact with the second inner surface 811 and the second outer surface 812. In an example, the second tab member 403 may include a second inner contact portion 430 in contact with the second inner surface 811 and a second outer contact portion 440 in contact with the second outer surface 812. The second inner contact portion 430 may be disposed parallel to the second inner surface 811. The second inner contact portion 430 may be formed by bending an upper area of the second tab member 403, which extends from the electrode assembly 200 in the third direction, to be in parallel with the first direction. The second inner contact portion 430 may be in contact with the second inner surface 811and may be joined to the second inner surface 811 by laser welding.

The second outer contact portion 440 may be disposed parallel to the second outer surface 812. The second inner contact portion 430 and the second outer contact portion 440 may parallel to each other with the second current collector plate 810 interposed therebetween.

The second outer contact portion 440 according to the present embodiment may be formed by bending an end area of the second inner contact portion 430, which is not in direct contact with the second inner surface 811, toward the second outer surface 812. The second outer contact portion 440 may be in contact with the second outer surface 812. An end portion of the second outer contact portion 440 may not protrude outward from the second outer surface 812. The second outer contact portion 440 may be joined to the second outer surface 812 by laser welding.

With the above-described configuration, in the secondary battery 2 all of the plurality of second tabs 404 may be connected to the second current collector plate 810 without increasing the width of the second sub-plate 800 in the first direction. In addition, the secondary battery 2 may have reduced electrical resistance between the second tab member 403 and the second terminal 700 and reduce a temperature rise by increasing a contact area between the second tab member 403 and the second sub-plate 800.

A portion of the second outer contact portion 440 may be disposed between the second outer surface 812 and the second terminal 700, more specifically, between the second outer surface 812 and the second inner terminal surface 701. The second outer contact portion 440 may be in direct contact with the second inner terminal surface 701. Accordingly, the secondary battery 2 may have further reduced electrical resistance between the second tab member 403 and the second terminal 700.

The second connecting plate 820 may extend from the second current collector plate 810 and may be connected to the second terminal 700. A plurality of second connecting plates 820 may be provided. In an example embodiment, a pair of second connecting plates 820 may be provided. The pair of second connecting plates 820 may face each other in the second direction. The pair of second connecting plates 820 may be disposed symmetrically on both sides of the second current collector plate 810.

The second connecting plate 820 may include a second extending plate 821 and a second terminal contact portion 822.

The second extending plate 821 may extend from the second current collector plate 810 and may be disposed to face the second outer surface 812. The second extending plate 821 may be bent from an end portion of the second current collector plate 810 toward the second outer surface 812. The second extending plate 821 may be disposed between the second current collector plate 810 and the cap plate 300. The second extending plate 821 may include a second inner extending surface 821a facing the second outer surface 812 and a second outer extending surface 821b facing the cap plate 300. The second inner extending surface 821a and the second outer extending surface 821b may be perpendicular to the third direction. The second inner extending surface 821a and the second outer extending surface 821b may be parallel to each other, with the second inner extending surface 821a spaced a predetermined distance apart from the second outer surface 812 in the third direction.

The second outer contact portion 440 may be disposed between the second outer surface 812 and the second inner extending surface 821a of the second extending plate 821. Surfaces of the second outer contact portion 440 may be in contact with the second outer surface 812 and the second inner extending surface 821a. The second outer contact portion 440 may be connected to the second extending plate 821 by laser welding.

The second terminal contact portion 822 may extend from the second extending plate 821 and may be in contact with an outer surface 703 of the second terminal 700. The second terminal contact portion 822 may be bent in the third direction from an end portion of the second extending plate 821. The second terminal contact portion 822 may be parallel to the outer surface 703 of the second terminal 700and in contact with the outer surface 703 of the second terminal 700. The second terminal contact portion 822 may be joined to the outer surface 703 of the second terminal 700, for example, by laser welding. Accordingly, the secondary battery 2 may be made in a simplified manufacturing process and have improved current density by directly connecting the second sub-plate 800 to the second terminal 700 without a separate current collecting component.

Referring again to FIG. 1, the battery module according to the present embodiment may include a plurality of secondary batteries 2. The plurality of secondary batteries 2 may be arranged in the first direction inside the housing 1. The number of secondary batteries 2 may vary depending on the size, shape, and the like of the housing 1.

The first terminal 500 of one of a pair of adjacent secondary batteries 2 and the second terminal 700 of the other secondary battery 2 may be disposed to face each other in the first direction. That is, the front surface portion 120 of one of the adjacent secondary batteries 2 may be disposed to face the rear surface portion 130 of the other secondary battery 2.

The plurality of secondary batteries 2 may be electrically connected by a busbar 3. The busbar 3 may be disposed between the cover 12 and the secondary battery 2. A plurality of busbars 3 may be provided. Each of the busbars 3 may connect a pair of adjacent secondary batteries 2 in series or parallel. In an example, both sides of the busbar 3 may be connected to a first terminal 500 of one of a pair of adjacent secondary batteries 2 and a second terminal 700 of the other. Accordingly, a plurality of secondary batteries 2 may be connected in series with each other by the busbar 3. However, the busbar 3 is not limited to this connection form, and it is possible for both sides of the busbar 3 are connected to either the first terminal 500 of one of a pair of adjacent secondary batteries 2 and the second terminal 700 of the other, or to the second terminal 700 of one of a pair of adjacent secondary batteries 2 and the second terminal 700 of the other.

The busbar 3 may be formed of an electrically conductive material such as copper, aluminum, or nickel. The specific shape of the busbar 3 is not limited to that illustrated in FIG. 1. Rather, the busbar 3 may be formed in various shapes that electrically connect adjacent secondary batteries 2.

The plurality of busbars 3 may be supported inside the housing 1 by busbar holders H. The busbar holder H may be a flat plate. The busbar holder H may be disposed between the cover 12 and the secondary battery 2. The busbar 3 may be fixed to the busbar holder H by various types of coupling methods such as fitting, bolting, injection joining, etc. The busbar holder H may be configured to include an electrically insulating polymer compound material.

Hereinafter, a battery module according to a second embodiment of the present disclosure will be described. The battery module according to the second embodiment may be configured to differ from the first embodiment with respect to the configuration of the secondary battery 2. Accordingly, in describing the battery module according to the present embodiment, only the configurations of the secondary battery 2 that are different from the battery module according to the first embodiment of the present disclosure will be described. For the other parts of the battery module according to the second embodiment, the description of the battery module according to the first embodiment applies.

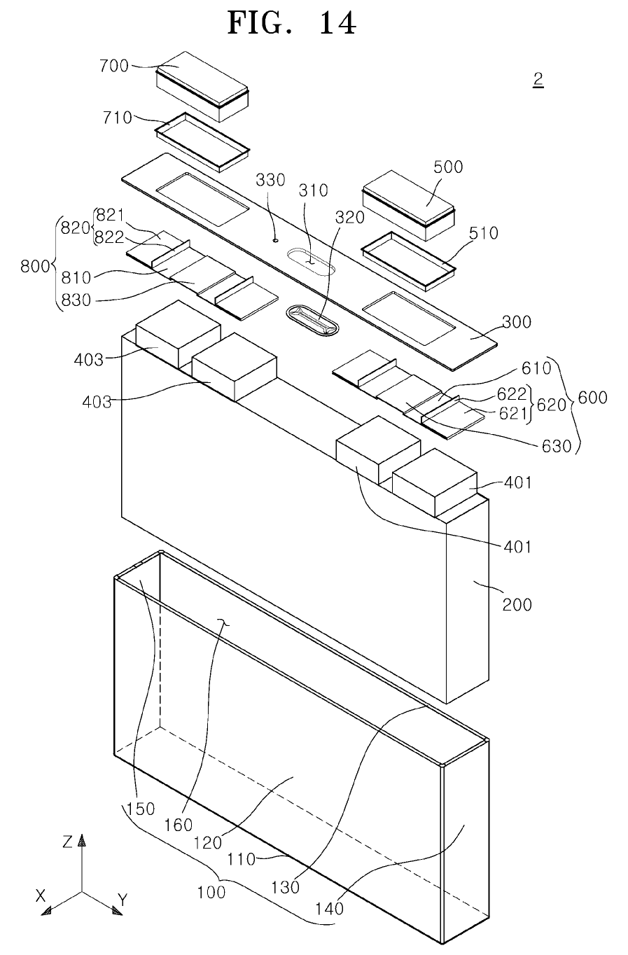

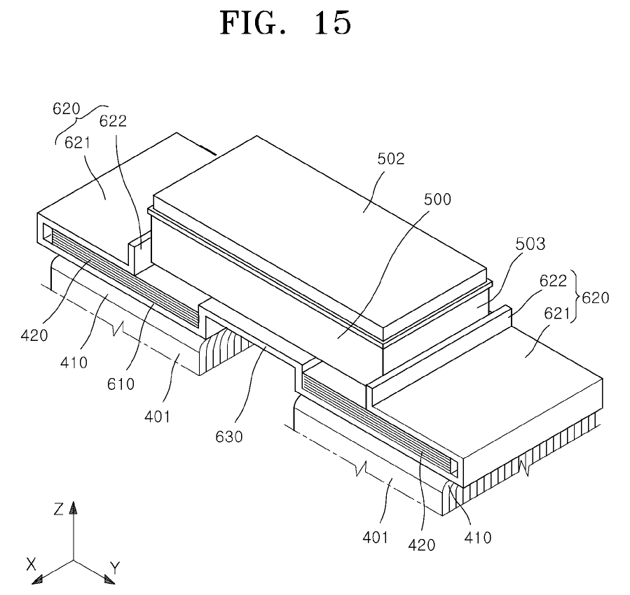

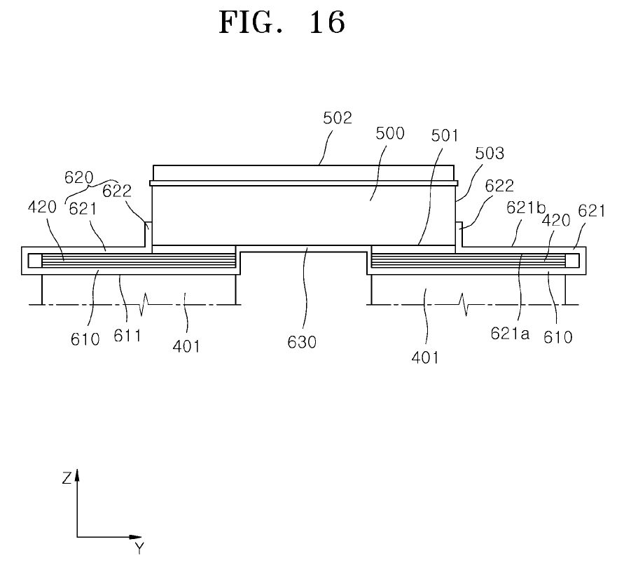

FIG. 14 is a perspective view of a secondary battery according to a second embodiment of the present disclosure, FIG. 15 is a perspective view of an installation state of a first sub-plate according to the second embodiment of the present disclosure, and FIG. 16 is a front view of the installation state of the first sub-plate according to the second embodiment of the present disclosure.

Referring to FIGS. 14 to 16, a plurality of first tab members 401 may be provided. For example, a pair of first tab members 401 may be formed. The pair of first tab members 401 may be arranged spaced a predetermined distance apart in the second direction.

A plurality of first current collector plates 610 according to the present embodiment may be provided. For example, a pair of first current collector plates 610 may be provided, and the pair of first current collector plates 610 may be arranged in the second direction. Each of the first current collector plates 610 may be disposed to face different first tab members 401 in the third direction.

The first inner contact portion 410 and the first outer contact portion 420 of each of the first tab members 401 may be contact with the first inner surface 611 and the first outer surface 612 of first current collector plates 610.

The first sub-plate 600 may further include a first center plate 630. The first center plate 630 may interconnect the plurality of first current collector plates 610.

The first center plate 630 may be disposed between the pair of first current collector plates 610 that are adjacent to the first center plate 630 in the second direction. FIGS. 14 to 16 illustrate an example in which a single first center plate 630 is formed. However, when three or more first current collector plates 610 are formed, a plurality of first center plates 630 may be provided. In such a case, each of the first center plates 630 may be disposed between the pair of first current collector plates 610 in the second direction.

Both end portions of the first center plate 630 may be connected to the pair of first current collector plates 610 that are adjacent to the first center plate 630 in the second direction. Accordingly, the first center plate 630 may be electrically connected to the first current collector plates 610.

The first center plate 630 may be disposed to face the first inner terminal surface 501 of the first terminal 500 and be in contact with the first inner terminal surface 501. The first center plate 630 may be connected to the first terminal 500 by laser welding or the like.

In this embodiment, the first center plate 630 may be disposed higher than the first current collector plate 610. Accordingly, the first outer contact portion 420 may be spaced a predetermined distance apart from the first inner terminal surface 501 of the first terminal 500.

One or more first connecting plates 620 may be connected to each of the first current collector plates 610. In this embodiment, a pair of first connecting plates 620 are provided, and each of the first connecting plates 620 extends from an end portion of a first current collector plate 610.

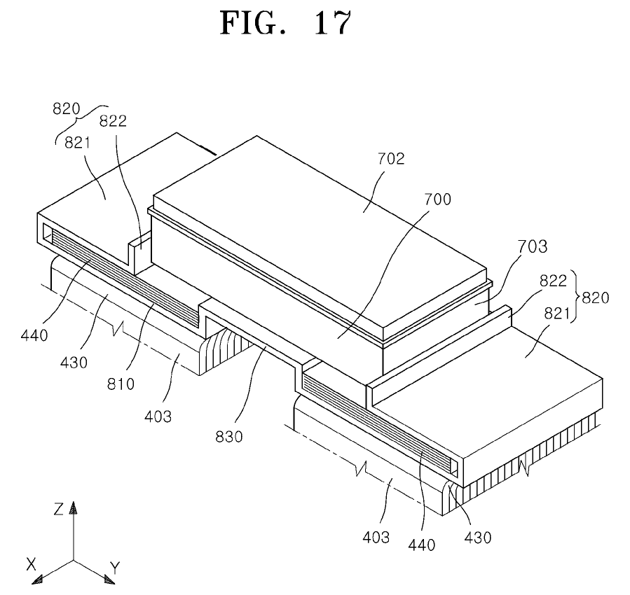

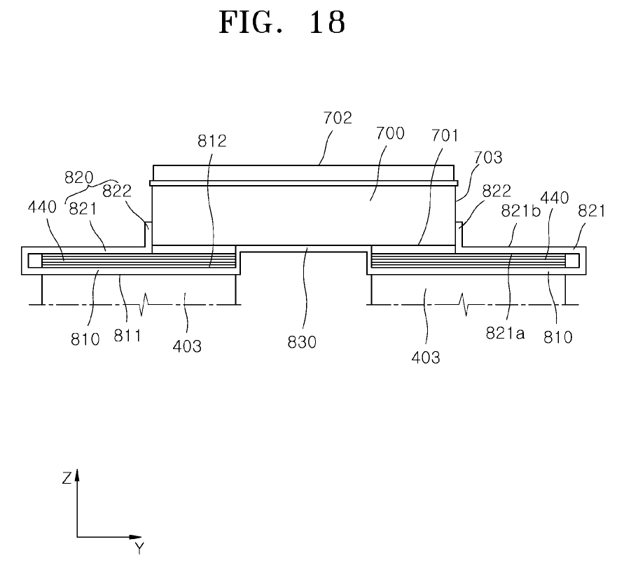

FIG. 17 is a perspective view of an installation state of a second sub-plate according to the second embodiment of the present disclosure, and FIG. 18 is a front view of the installation state of the second sub-plate according to the second embodiment of the present disclosure.

Referring to FIGS. 14, 17, and 18, a plurality of second tab members 403 may be provided. As illustrated in FIG. 14, a pair of second tab members 403 may be formed. The pair of second tab members 403 may be arranged in the second direction and spaced a predetermined distance apart in the second direction.

A plurality of second current collector plates 810 according to the present embodiment may be provided. For example, a pair of second current collector plates 810 may be provided, and the pair of second current collector plates 810 may be arranged in the second direction. Each of the second current collector plates 810 may face a different second tab member 403 in the third direction.

The second inner contact portion 430 and the second outer contact portion 440 of each of the second tab members 403 may be in contact with the second inner surface 811 and the second outer surface 812 of different second current collector plates 810.

The second sub-plate 800 according to the present embodiment may further include a second center plate 830. The second center plate 830 may interconnect the plurality of second current collector plates 810.

The second center plate 830 may be disposed between the pair of second current collector plates 810 that are adjacent to the second center plate 830 in the second direction. FIGS. 17 and 18 illustrate an example in which a single second center plate 830 is formed. However, when three or more second current collector plates 810 are formed, a plurality of second center plates 830 may be provided. In such a case, each of the second center plates 830 may be disposed between the pair of second current collector plates 810 in the second direction.

Both end portions of the second center plate 830 may be connected to the pair of second current collector plates 810 that are disposed adjacent to the second center plate 830 in the second direction. Accordingly, the second center plate 830 may be electrically connected to the plurality of second current collector plates 810.

The second center plate 830 may face the second inner terminal surface 701 of the second terminal 700 and be in contact with the second inner terminal surface 701. The second center plate 830 may be connected to the second terminal 700 by laser welding or the like.

The second center plate 830 may be disposed to be higher than the second current collector plate 810. Accordingly, the second outer contact portion 440 may be spaced a predetermined distance apart from the second inner terminal surface 701 of the second terminal 700.

One or more second connecting plates 820 may be connected to each of the second current collector plates 810 according to the present embodiment. For example, a pair of second connecting plates 820 may extend from end portions of second current collector plates 810.

Hereinafter, a battery module according to a third embodiment of the present disclosure will be described. The battery module according to the third embodiment may differ from the battery module according to the second embodiment of the present disclosure only with respect to the secondary battery 2. Accordingly, only the parts of the secondary battery 2 that are different from the battery module according to the second embodiment of the present disclosure. The other parts of the battery module according to the present embodiment may be the same as in the battery module described above.

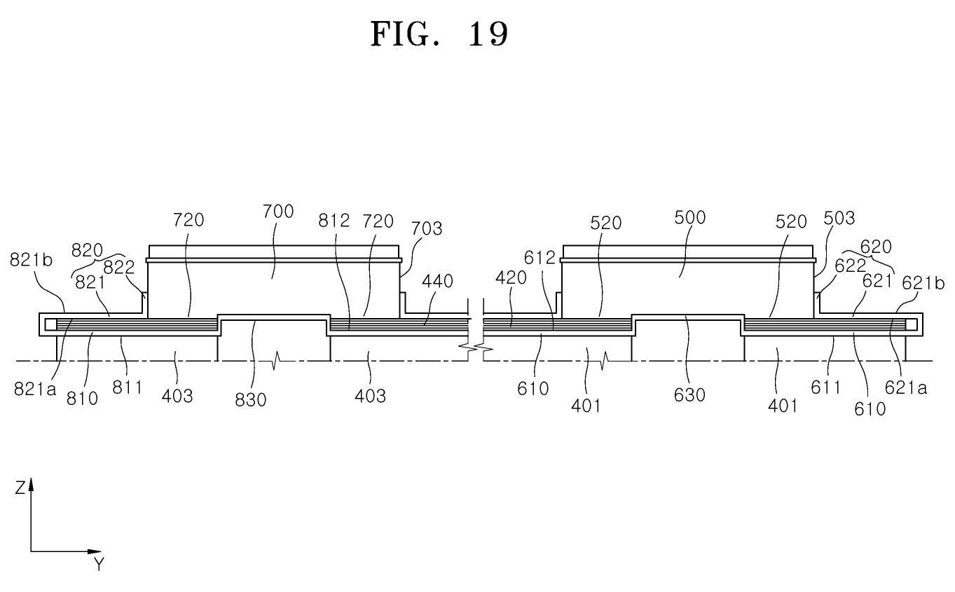

FIG. 19 is a cross-sectional view of a secondary battery according to a third embodiment of the present disclosure.

Referring to FIG. 19, the secondary battery 2 according to the present embodiment may further include a first terminal extending portion 520. The first terminal extending portion 520 may extend from the first terminal 500 toward the first outer surface 612 and may be in contact with the first tab member 401. The first terminal extending portion 520 directly contact with the first terminal 500 and the first tab member 401 by extending a distance between the first terminal 500 and the first tab member 401 due to a height difference between the first center plate 630 and the first current collector plate 610. Accordingly, the secondary battery 2 may have reduced electrical resistance between the first terminal 500 and the first tab member 401.

The first terminal extending portion 520 may extend from the first inner terminal surface 501 of the first terminal 500 toward the first outer contact portion 420 seated on the first outer surface 612, with the first terminal extending portion 520 being in contact with the first outer contact portion 420. The first terminal extending portion 520 may contact the first outer contact portion 420 but not connected to the first outer contact portion 420. In other embodiments, the first outer contact portion 420 may be integrally joined with the first outer contact portion 420 by laser welding or the like.

The first terminal extending portion 520 may be disposed to surround the first center plate 630 to prevent interference with the first center plate 630. The first center plate 630 may be inserted into the inside of a space surrounded by an inner surface of the first terminal extending portion 520.

The secondary battery 2 according to the present embodiment may further include a second terminal extending portion 720. The second terminal extending portion 720 may extend from the second terminal 700 toward the second outer surface 812 and may be in contact with the second tab member 403. The second terminal extending portion 720 may directly contact the second terminal 700 and the second tab member 403 by extending the distance between the second terminal 700 and the second tab member 403 that arises because of a height difference between the second center plate 830 and the second current collector plate 810. Accordingly, the secondary battery 2 electrical resistance between the second terminal 700 and the second tab member 403 may be reduced.

The second terminal extending portion 720 may extend from the second inner terminal surface 701 of the second terminal 700 toward the second outer contact portion 440 seated on the second outer surface 812. The second terminal extending portion 720 may be in contact with the second outer contact portion 440. The second terminal extending portion 720 may be in contact with the second outer contact portion 440 but not connected to the second outer contact portion 440. In other embodiments, the second terminal extending portion 720 may be integrally joined with the second outer contact portion 440 by laser welding or the like.

The second terminal extending portion 720 may surround the second center plate 830 to thereby prevent interference with the second center plate 830. As such, the second center plate 830 may be inserted into the inside of a space surrounded by an inner surface of the second terminal extending portion 720.

Hereinafter, a battery module according to a fourth embodiment of the present disclosure will be described. The battery module according to the fourth embodiment differs from the battery modules according to the first to third embodiments of the present disclosure in the configuration of the secondary battery 2. Accordingly, in describing the battery module according to the fourth embodiment, the features of the secondary battery 2 that are different from the battery module according to the first to third embodiments of the present disclosure will be described. The other parts of the battery module according to the fourth embodiment may be the same as in the battery modules described above.

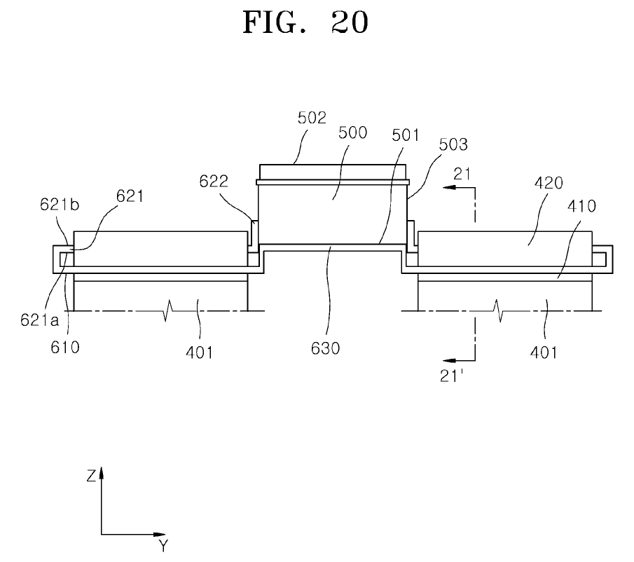

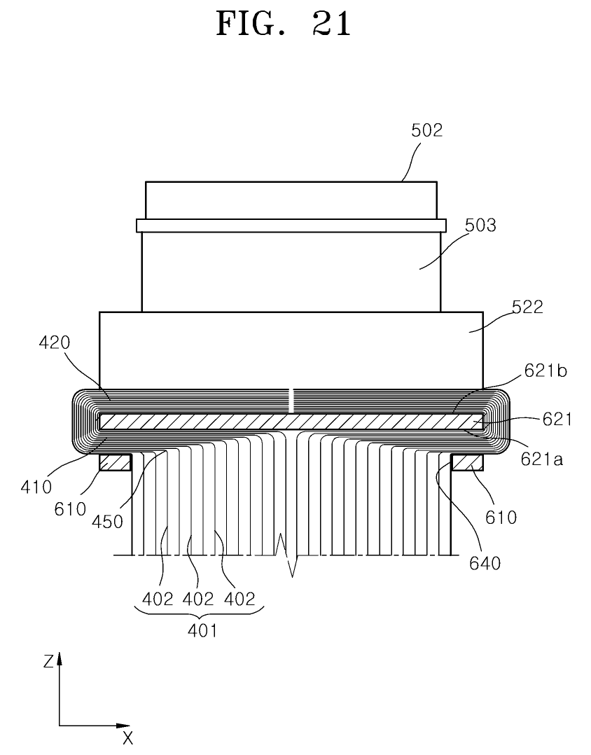

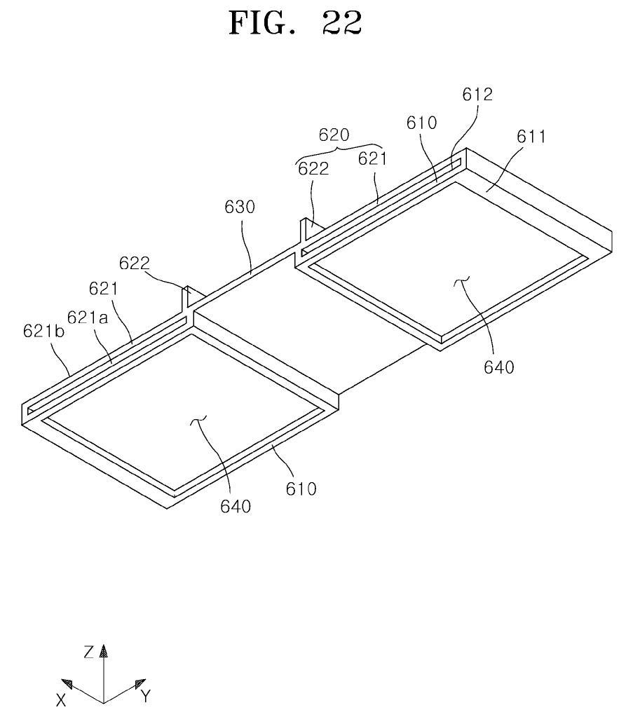

FIG. 20 is a front view of an installation state of a first sub-plate according to a fourth embodiment of the present disclosure, FIG. 21 is a cross-sectional view along line 21-21' in FIG. 20, and FIG. 22 is a bottom perspective view of the first sub-plate according to the fourth embodiment of the present disclosure.

Referring to FIGS. 20 to 22, the first sub-plate 600 according to the present embodiment may further include a first insertion hole 640. The first insertion hole 640 may extend between the first inner surface 611 and the first outer surface 612 of the first current collector plate 610. An area of the first insertion hole 640 may be larger than an area of the first tab member 401. A plurality of first insertion holes 640 may be provided. Each of the first insertion holes 640 may correspond to a first current collector plate 610.

The first tab member 401 may be connected to the first connecting plate 620 through the first insertion hole 640.

As an example, the first tab member 401 may further include a first insertion portion 450 inserted into the first insertion hole 640. The first insertion portion 450 may refer be an upper area of the first tab member 401 that passes through the first insertion hole 640 and is disposed between the first outer surface 612 and the first inner extending surface 621a.

The first inner contact portion 410 may extend from the first insertion portion 450 and may be in contact with the first inner extending surface 621a. For example, the first inner contact portion 410 may be bent from the first insertion portion 450 in the first direction. More specifically, the first inner contact portion 410 may be formed by bending an upper end area of the first insertion portion 450that is disposed between the first outer surface 612 and the first inner extending surface 621a.

The first inner contact portion 410 may be parallel to the first outer surface 612 and the first inner extending surface 621a. Surfaces of the first inner contact portion 410 may be in contact with the first outer surface 612 and the first inner extending surface 621a. The first inner contact portion 410 may be joined to the first current collector plate 610 and the first connecting plate 620 by laser welding or the like.

A pair of first inner contact portions 410 are provided and the pair of first inner contact portions 410 may branch off in different directions from the first insertion portion 450. In an example, the pair of first inner contact portions 410 may be bent in opposite directions from the first insertion portion 450.

The first outer contact portion 420 may extend from the first inner contact portion 410 and may be in contact with the first outer extending surface 621b. The first outer contact portion 420 may be formed by bending the end area of the first inner contact portion 410 that is not in direct contact with the first outer surface 612 and the first inner extending surface 621a toward the first outer extending surface 621b.

The first outer contact portion 420 may be parallel to the first outer extending surface 621b. The first outer contact portion 420 may contact the first outer extending surface 621b and may be joined to the first outer extending surface 621b by laser welding or the like. The end portion of the first outer contact portion 420 may not protrude outward from the first outer extending surface 621b.

A pair of first outer contact portions 420 may be provided. Each of the first outer contact portions 420 may be bent in opposite directions from an end portion of a different first inner contact portion 410.

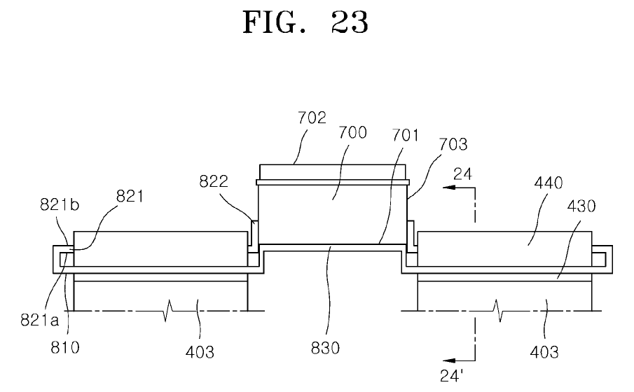

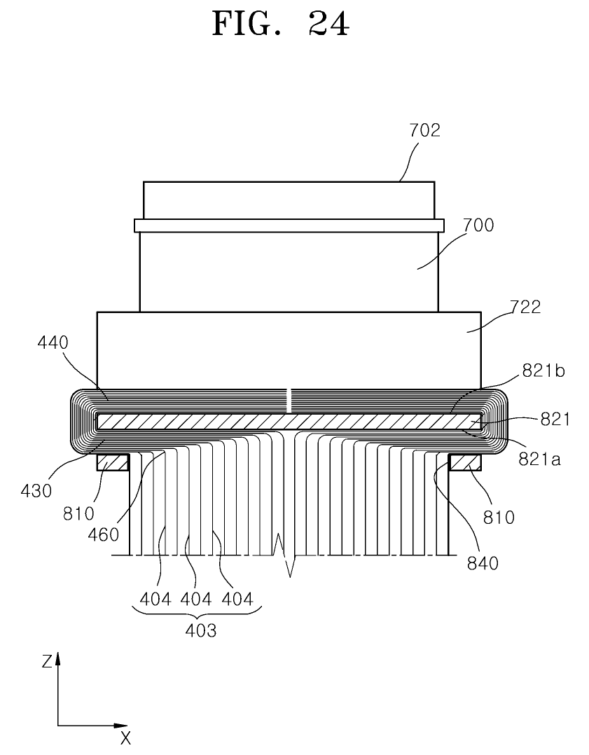

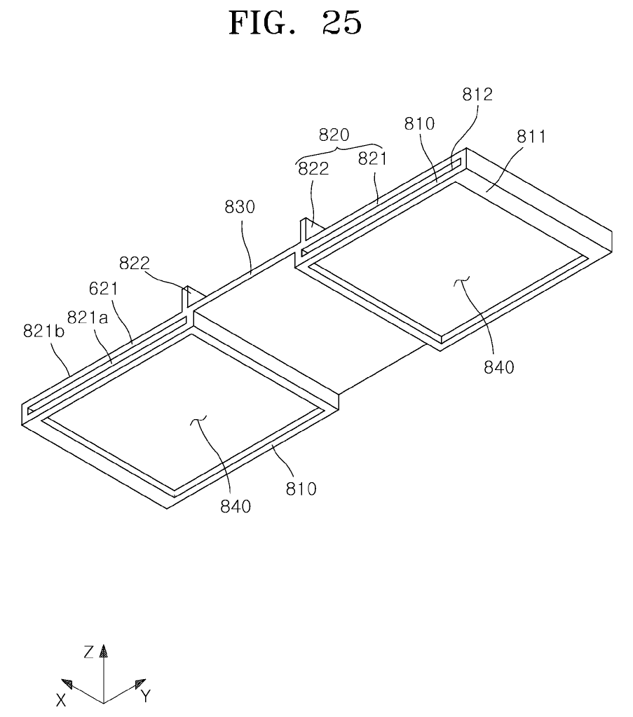

FIG. 23 is a front view of an installation state of a second sub-plate according to the fourth embodiment of the present disclosure, FIG. 24 is a cross-sectional view along line 24-24' in FIG. 23, and FIG. 25 is a bottom perspective view of a configuration of the second sub-plate according to the fourth embodiment of the present disclosure.

Referring to FIGS. 23 to 25, the second sub-plate 800 according to the fourth embodiment may further include a second insertion hole 840. The second insertion hole 840 may extend between the second inner surface 811 and the second outer surface 812 of the second current collector plate 810. An area of the second insertion hole 840 may be larger than an area of the second tab member 403. A plurality of second insertion holes 840 may be provided. Each of the second insertion holes 840 may correspond to a second current collector plate 810.

The second tab member 403 may be connected to the second connecting plate 820 through the second insertion hole 840.

In an example, the second tab member 403 may further include a second insertion portion 460 inserted into the second insertion hole 840. The second insertion portion 460 may be an upper area of the second tab member 403 that passes through the second insertion hole 840 and is disposed between the second outer surface 812 and the second inner extending surface 821a.

The second inner contact portion 430 may extend from the second insertion portion 460 and may be in contact with the second inner extending surface 821a. For example, the second inner contact portion 430 may be bent from the second insertion portion 460 in the first direction. More specifically, the second inner contact portion 430 may be formed by bending an upper end area of the second insertion portion 460 that is disposed between the second outer surface 812 and the second inner extending surface 821a.

The second inner contact portion 430 may be disposed parallel to the second outer surface 812 and the second inner extending surface 821a. Surfaces of the second inner contact portion 430 may in contact with the second outer surface 812 and the second inner extending surface 821a. The second inner contact portion 430 may be joined to the second current collector plate 810 and the second connecting plate 820 by laser welding or the like.

A pair of second inner contact portions 430 are provided, and the pair of second inner contact portions 430 may branch off in different directions from the second insertion portion 460. For example, the pair of second inner contact portions 430 may be bent in opposite directions from the second insertion portion 460.

The second outer contact portion 440 may extend from the second inner contact portion 430 and may be in contact with the second outer extending surface 821b. The second outer contact portion 440 may be formed by bending the end area of the second inner contact portion 430 that is not in direct contact with the second outer surface 812 and the second inner extending surface 821a toward the second outer extending surface 821b.

The second outer contact portion 440 may be disposed parallel to the second outer extending surface 821b. The second outer contact portion 440 may be in contact with the second outer extending surface 821b and may be joined to the second outer extending surface 821b by laser welding or the like. The end portion of the second outer contact portion 440 may not protrude outward from the second outer extending surface 821b.

A pair of second outer contact portions 440 may be provided. Each of the second outer contact portions 440 may be bent in opposite directions from an end portion of a different second inner contact portion 430.

According to the present disclosure, the electrical resistance between an electrode assembly and a terminal can be reduced, and temperature rise generated during the operation of a secondary battery can be prevented or minimized.

According to the present disclosure, a secondary battery manufacturing process can be simplified and the current density of the secondary battery can be increased by directly connecting a sub-plate to the terminal without a separate current collecting component.

However, the effects obtainable through the present disclosure are not limited to the above effects, and other technical effects that are not mentioned will be clearly understood by those skilled in the art from the description of the present disclosure.

While the present disclosure has been described with reference to embodiments shown in the drawings, these embodiments are merely illustrative and it should be understood that various modifications and equivalent other embodiments can be derived by those skilled in the art on the basis of the embodiments.

What is claimed is:

1. A secondary battery comprising:
a case;
an electrode assembly disposed inside the case and provided with a first electrode and a second electrode;
a cap plate coupled to the case and facing the electrode assembly;
a tab member connected to the first electrode and extending toward the cap plate;
a terminal extending through the cap plate and spaced from the tab member; and
a sub-plate disposed between the tab member and the terminal, with the sub-plate connected to the tab member and the terminal.

2. The secondary battery as claimed in claim 1, wherein the sub-plate comprises:
a current collector plate provided with an inner surface facing the tab member and an outer surface facing the cap plate, with the current collector plate being connected to the tab member; and
a connecting plate extending from the current collector plate and connected to the terminal.

3. The secondary battery as claimed in claim 2, wherein the tab member is in contact with the inner surface and the outer surface.

4. The secondary battery as claimed in claim 3, wherein the tab member comprises:
an inner contact portion in contact with the inner surface; and
an outer contact portion extending from the inner contact portion and in contact with the outer surface.

5. The secondary battery as claimed in claim 4, wherein the inner contact portion and the outer contact portion are parallel to each other and face each other with the current collector plate interposed therebetween.

6. The secondary battery as claimed in claim 4, wherein the outer surface is spaced from the terminal, and the outer contact portion is disposed between the outer surface and the terminal.

7. The secondary battery as claimed in claim 6, wherein the outer contact portion is in contact with the terminal.

8. The secondary battery as claimed in claim 4, wherein the connecting plate comprises:
an extending plate extending from the current collector plate and facing the outer surface; and
a terminal contact portion extending from the extending plate and contacting an outer surface of the terminal.

9. The secondary battery as claimed in claim 8, wherein the extending plate is spaced from the outer surface, and the outer contact portion is disposed between the outer surface and the extending plate.

10. The secondary battery as claimed in claim 9, wherein the outer contact portion is in contact with the extending plate.

11. The secondary battery as claimed in claim 1, wherein:
a plurality of tab members are provided; and
the sub-plate comprises:
a center plate;
a plurality of current collector plates extending from the center plate and facing of the tab members; and
a connecting plate extending from the current collector plate and connected to the terminal.

12. The secondary battery as claimed in claim 11, wherein the center plate is in contact with the terminal.

13. The secondary battery as claimed in claim 11, wherein each of the current collector plates comprises:
an inner surface facing one of the tab members; and
an outer surface opposite to the inner surface, the outer surface facing and spaced from the terminal, and
wherein each of the tab members is in contact with the inner surface and the outer surface of one of the current collector plates.

14. The secondary battery as claimed in claim 13, further comprising a terminal extending portion extending from the terminal toward the outer surface of one of the current collector plates and in contact with one of the tab members.

15. The secondary battery as claimed in claim 14, wherein the terminal extending portion surrounds the center plate.

16. The secondary battery as claimed in claim 1, wherein the sub-plate comprises:
a current collector plate provided with an inner surface facing the electrode assembly and an outer surface facing the cap plate;
a connecting plate extending from the current collector plate and connected to the terminal; and
an insertion hole extending between the inner surface and the outer surface, and
the tab member is connected to the connecting plate through the insertion hole.

17. The secondary battery as claimed in claim 16, wherein the connecting plate comprises:
a extending plate provided with (i) an inner extending surface extending from the current collector plate and facing the outer surface and (ii) an outer extending surface facing the cap plate; and
a terminal contact portion extending from the extending plate and in contact with an outer surface of the terminal, and
the tab member comprises:
an insertion portion inserted into the insertion hole;
an inner contact portion extending from the insertion portion and in contact with the inner extending surface; and
an outer contact portion extending from the inner contact portion and in contact with the outer extending surface.

18. The secondary battery as claimed in claim 17, wherein a pair of inner contact portions are provided, and the pair of inner contact portions branch off in different directions from the insertion portion.

19. The secondary battery as claimed in claim 1, wherein the tab member is a first tab member, the terminal is a first terminal, and the sub-plate is a first sub-plate, and
wherein the secondary battery further comprises:
a second tab member connected to the second electrode and extending toward the cap plate;
a second terminal extending through the cap plate and spaced from the second tab member; and
a second sub-plate disposed between the second tab member and the second terminal and connected to the second tab member and the second terminal.

20. A battery module comprising:
a housing; and
a plurality of secondary batteries disposed inside the housing,
wherein each of the secondary batteries comprises:
a case;
an electrode assembly disposed inside the case and provided with a first electrode and a second electrode;
a cap plate coupled to the case and facing the electrode assembly;
a tab member connected to the first electrode and extending toward the cap plate;
a terminal extending through the cap plate and spaced from the tab member; and
a sub-plate disposed between the tab member and the terminal, with the sub-plate connected to the tab member and the terminal.
